(19) United States
(12) Patent Application Publication
(10) Pub. No.: US 2026/0048362 A1
(43) Pub. Date: Feb. 19, 2026

(54) SIMULTANEOUS CARBON DIOXIDE AND HYDROGEN RECOVERY FROM THE TAIL GAS STREAM OF A SULFUR RECOVERY UNIT

(71) Applicant: Saudi Arabian Oil Company, Dhahran (SA)

(72) Inventors: Feras Hamad, Dhahran (SA); Sebastien Andre Duval, Dhahran (SA); Milind Vaidya, Dhahran (SA); Ghulam Shabbir, Dhahran (SA); Ahmad Bahamdan, Dammam (SA); Seung-Hak Choi, Incheon (KR)

(73) Assignee: Saudi Arabian Oil Company, Dhahran (SA)

(21) Appl. No.: 18/804,908

(22) Filed: Aug. 14, 2024

(51) Int. Cl. B01D 53/22; B01D 53/00; B01D 53/047; B01D 53/26; C01B 3/50; C01B 3/56; C01B 32/50

(52) U.S. Cl. CPC B01D 53/229; B01D 53/002; B01D 53/047; B01D 53/226; B01D 53/261; C01B 3/501; C01B 3/56; C01B 32/50; B01D 2253/116; B01D 2256/16; B01D 2256/22; B01D 2257/102; B01D 2257/304; B01D 2257/80; C01B 2203/0405; C01B 2203/043

(57) ABSTRACT

Processes and systems are provided for treating the tail gas stream of a sulfur recovery plant. The process comprising the steps of treating the compressed tail gas stream in a pre-treatment unit to remove the impurities; separating the dry stream in a first stage membrane unit, the first stage membrane unit comprises a membrane selective to carbon dioxide and hydrogen; reducing a temperature of the cryogenic feed in a cryogenic cooler to produce a cryogenic stream; separating the cryogenic feed in a knock-drum to produce a liquid carbon dioxide and membrane feed; separating the membrane feed in a second stage membrane unit to produce a rubbery membrane permeate and a rubbery membrane retentate, where the second stage membrane unit comprises a membrane selective to carbon dioxide over hydrogen; and treating the rubbery membrane retentate in a hydrogen recovery process to produce a hydrogen product stream and a carbon dioxide lean stream.

### TECHNICAL FIELD

This disclosure relates to methods and systems for treating a tail gas stream from a sulfur recovery unit. More specifically, this disclosure relates to recovering hydrogen and carbon dioxide from a tail gas stream from a sulfur recovery unit.

### BACKGROUND

The sulfur recovery unit (SRU) is essential for the production and operation of the oil and gas industry. The sulfur, in any form, for example, hydrogen sulfide (H₂S) or mercaptans, in natural gas products can be extracted or removed to meet environmental sulfur emissions regulations.

The tail gas exiting the SRU is mainly composed of nitrogen and carbon dioxide. Other gases present in the tail gas can include H₂S, sulfur dioxide (SO₂), elemental sulfur vapor and other sulfurous hydrocarbon compounds, argon, helium, and hydrogen. The volumes of the other gases are low, typically less than 5 vol %. To meet the environmental regulations, sulfurous compounds have to be reduced down to less than 225 ppm before directing it to the thermal oxidizer (TOX). To reduce the sulfur content, one option is to treat the tail gas stream through a hydrogenation and/or hydrolysis reactor to convert all sulfur species into H₂S. In an alternative approach, sulfurous species in the tail gas are oxidized to SO₂ in a thermal or catalytic oxidizer. Exiting the hydrogenation reactor or oxidation unit, the tail gas is directed to a tail gas treatment unit, which is amine-based technology that recovers H₂S (or SO₂) selectively, along with a portion of CO₂. The acid gas recovered by the tail gas treatment unit is recycled back to the furnace of the SRU. The cleaned gas from the tail gas treatment unit is directed to the TOX.

Hydrogen exists in the tail gas of the SRU. It is produced mainly from the thermal cracking of H₂S and hydrocarbons in the furnace of the SRU. The amount of hydrogen in the tail gas depends on the level of H₂S and hydrocarbons in the feed acid gas to the SRU, and the temperature of the furnace of the SRU.

SRUs are considered a major source for carbon dioxide emissions in the oil and gas industry. Carbon dioxide capture has had a new focus to develop improved technologies over those currently available. Currently available methods of carbon dioxide capture suffer due to the relatively small amounts of carbon dioxide in the tail gas stream resulting in energy intensive processes with low efficiency for separation of carbon dioxide.

### SUMMARY

This disclosure relates to methods and systems for treating a tail gas stream from a sulfur recovery unit. More specifically, this disclosure relates to recovering hydrogen and carbon dioxide from a tail gas stream from a sulfur recovery unit.

In a first aspect, a process to recover carbon dioxide and hydrogen from a tail gas stream is provided. The process includes the steps of compressing the tail gas stream in a tail gas compressor to produce a compressed tail gas stream, where the tail gas stream includes hydrogen, carbon dioxide, nitrogen and impurities, treating the compressed tail gas stream in a pre-treatment unit to remove the impurities to produce a dry stream, separating the dry stream in a first stage membrane unit to produce a permeate stream and a retentate stream, where the first stage membrane unit includes a membrane selective to carbon dioxide and hydrogen over nitrogen, where the permeate stream includes carbon dioxide and hydrogen, where the retentate stream includes nitrogen, expanding the retentate stream in a turbo-expander to produce an expanded stream, compressing the permeate stream in a compressor to produce a compressed permeate stream, cooling the compressed permeate stream in a permeate exchanger to produce a cooled permeate stream, reducing a temperature of the cooled permeate stream in an exhaust exchanger to produce a cryogenic feed, where the temperature of the cooled permeate stream is reduced by heat exchange with the expanded stream. The process further includes the steps of reducing a temperature of the cryogenic feed in a cryogenic cooler to produce a cryogenic stream, where a temperature of the cryogenic stream induces precipitation of carbon dioxide at the pressure of the cryogenic stream, separating the cryogenic feed in a knock-drum to produce a liquid carbon dioxide and membrane feed, where the knock-out drum is at the temperature and pressure of the cryogenic stream, where the liquid carbon dioxide includes the precipitated liquid carbon dioxide, where the membrane feed includes carbon dioxide and hydrogen, separating the membrane feed in a second stage membrane unit to produce a rubbery membrane permeate and a rubbery membrane retentate, where the second stage membrane unit includes a membrane selective to carbon dioxide over hydrogen, where the rubbery membrane permeate includes carbon dioxide, where the rubbery membrane retentate includes hydrogen, and treating the rubbery membrane retentate in a hydrogen recovery process to produce a hydrogen product stream and a carbon dioxide lean stream, where the hydrogen recovery process is selected from the group consisting of a pressure swing adsorption unit, a hydrogen recovery membrane, a molecular centrifuge, and combinations of the same, where the hydrogen product includes hydrogen.

In certain aspects, the tail gas stream further includes argon, helium, and carbon monoxide. In certain aspects, the impurities are selected from hydrogen sulfide, water vapor, and combinations of the same. In certain aspects, the compressed tail gas stream is at a pressure between 250 psig and 350 psig. In certain aspects, the pre-treatment unit includes molecular sieves. In certain aspects, the compressed permeate stream is at a pressure between 410 psig and 460 psig. In certain aspects, the process further includes the step of increasing a temperature of the expanded stream in the exhaust exchanger to produce an exhaust, where the exhaust includes greater than 90 vol % nitrogen. In certain aspects, the membrane feed further includes nitrogen and the rubbery membrane retentate further includes nitrogen. In certain aspects, the process further includes a carbon dioxide rich stream produced from the hydrogen recovery process. In certain aspects, the hydrogen product includes greater than 90 vol % hydrogen. In certain aspects, the hydrogen recovery process includes one or more pressure swing adsorption units. In certain aspects, the hydrogen recovery process includes one or more gas separation membranes selective to hydrogen over nitrogen. In certain aspects, the process further includes the step of mixing the carbon dioxide lean stream with the retentate stream, where the carbon dioxide lean stream includes nitrogen. In certain aspects, the process further includes the step of mixing the carbon dioxide lean stream with the exhaust, where the carbon dioxide lean stream includes nitrogen. In certain aspects, the process further includes the step of mixing the rubbery membrane permeate with the permeate stream. In certain aspects, the process further includes the step of increasing a pressure of the liquid carbon dioxide to produce a carbon dioxide product.

In a second embodiment, a system to recover carbon dioxide and hydrogen from a tail gas stream is provided. The system includes a tail gas compressor, the tail gas compressor configured to compress the tail gas stream to produce a compressed tail gas stream, where the tail gas stream includes hydrogen, carbon dioxide, nitrogen and impurities, a pre-treatment unit fluidically connected the tail gas compressor, the pre-treatment unit configured to treat the compressed tail gas stream to remove the impurities to produce a dry stream, a first stage membrane unit fluidically connected to the pre-treatment unit, the glassy membrane configured to separate the dry stream to produce a permeate stream and a retentate stream, where the first stage membrane unit includes a membrane selective to carbon dioxide and hydrogen over nitrogen, where the permeate stream includes carbon dioxide and hydrogen, where the retentate stream includes nitrogen, a turbo-expander fluidically connected to a retentate side of the first stage membrane unit, the turbo-expander configured to expand the retentate stream to produce an expanded stream, a compressor fluidically connected to a permeate side of the first stage membrane unit, the compressor configured to produce a compressed permeate stream, a permeate exchanger fluidically connected to the compressor, the permeate exchanger configured to cool the compressed permeate stream to produce a cooled permeate stream, and an exhaust exchanger fluidically connected to the permeate exchanger and the turbo-expander, the exhaust exchanger configured to reduce a temperature of the cooled permeate stream to produce a cryogenic feed, where the temperature of the cooled permeate stream is reduced by heat exchange with the expanded stream. The system further includes a cryogenic cooler fluidically connected to the exhaust exchanger, the cryogenic cooler configured to reduce a temperature of the cryogenic feed to produce a cryogenic stream, where a temperature of the cryogenic stream induces precipitation of carbon dioxide at the pressure of the cryogenic stream, a knock-drum fluidically connected to the cryogenic cooler, the knock-out drum configured separate the cryogenic feed to produce a liquid carbon dioxide and membrane feed, where the knock-out drum is at the temperature and pressure of the cryogenic stream, where the liquid carbon dioxide includes the precipitated liquid carbon dioxide, where the membrane feed includes carbon dioxide and hydrogen, a second stage membrane unit fluidically connected to the knock-out drum, the rubbery membrane configured to separate the membrane feed to produce a rubbery membrane permeate and a rubbery membrane retentate, where the second stage membrane unit includes a membrane selective to carbon dioxide over hydrogen, where the rubbery membrane permeate includes carbon dioxide, where the rubbery membrane retentate includes hydrogen, and a hydrogen recovery process fluidically connected to a retentate side of the second stage membrane unit, the hydrogen recovery process configured to treat the rubbery membrane retentate to produce a hydrogen product stream and a carbon dioxide lean stream, where the hydrogen recovery process is selected from the group consisting of a pressure swing adsorption unit, a hydrogen recovery membrane, a molecular centrifuge, and combinations of the same, where the hydrogen product includes hydrogen.

### BRIEF DESCRIPTION OF THE DRAWINGS

These and other features, aspects, and advantages of the present disclosure will become better understood with regard to the following descriptions, claims, and accompanying drawings. It is to be noted, however, that the drawings illustrate only several embodiments of the disclosure and are therefore not to be considered limiting of the scope as it can admit to other equally effective embodiments.

FIG. 1 is a block diagram of a membrane cryogenic carbon capture and hydrogen recovery process and system, according to an embodiment.

FIG. 2 is a block diagram of a membrane cryogenic carbon capture and hydrogen recovery process with a pressure swing adsorption unit and a hydrogen recovery membrane, in accordance with another embodiment.

FIG. 3 is a block diagram of a membrane cryogenic carbon capture and hydrogen recovery process with a hydrogen recovery membrane, in accordance with another embodiment.

FIG. 4 is a block diagram of a membrane cryogenic carbon capture and hydrogen recovery process with a two-stage hydrogen recovery membrane, in accordance with another embodiment.

FIG. 5 is a block diagram of a membrane cryogenic carbon capture and hydrogen recovery process with a pressure swing adsorption unit and a nitrogen pressure swing adsorption unit, in accordance with another embodiment.

FIG. 6 is a block diagram of a membrane cryogenic carbon capture and hydrogen recovery process with a molecular centrifuge, in accordance with another embodiment.

FIG. 7 is a block diagram of a membrane cryogenic carbon capture and hydrogen recovery process with a hydrogen recovery membrane, in accordance with Example 6.

FIG. 8 is a block diagram of a tail gas treatment unit of the prior art for Example 7.

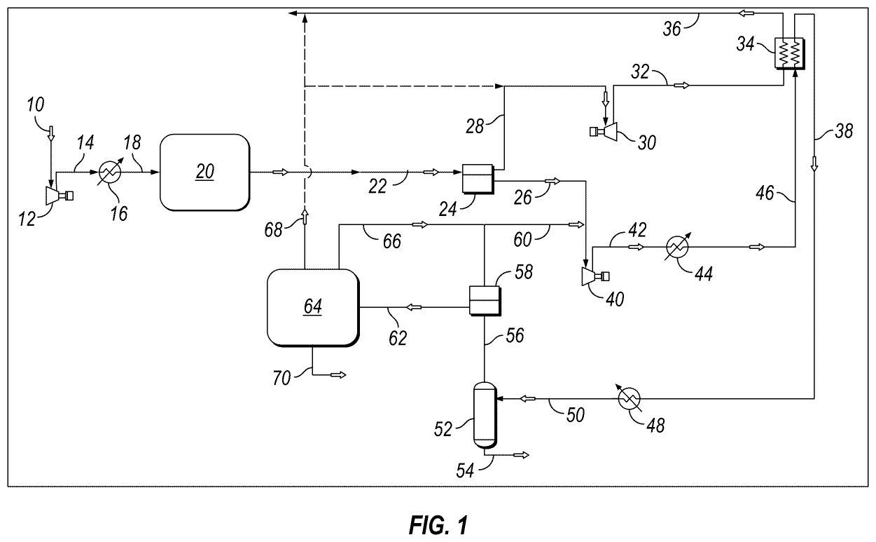

In the accompanying Figures, similar components or features, or both, can have a similar reference label. For the purpose of the simplified schematic illustrations and descriptions of FIGS. 1 through 8, the numerous pumps, valves, temperature and pressure sensors, electronic controllers, and the like that can be employed and well known to those of ordinary skill in the art are not included. Transfer lines between the various components of the system can include pipes, conduits, channels, or other suitable physical transfer lines that connect by fluidic communication one or more system components to one or more other system components. Further, accompanying components that are in conventional industrial operations are not depicted. However, operational components, such as those described in the present disclosure, can be added to the embodiments described in this disclosure.

It should further be noted that lines and arrows in the drawings refer to transfer lines which can serve to depict streams between two or more system components. Additionally, lines and arrows that connect to system components define inlets or outlets in each given system component. The arrow direction corresponds generally with the major direction of movement of the materials of the stream contained within the physical transfer line signified by the line and arrow. Furthermore, lines and arrows which do not connect two or more system components signify a product stream which exits the depicted system or a system inlet stream which enters the depicted system. Product streams can be further processed in processing systems or can be end products. System inlet streams can be streams transferred from accompanying processing systems or can be processed or non-processed feed streams.

### DETAILED DESCRIPTION

While the disclosure will be described with several embodiments, it is understood that one of ordinary skill in the relevant art will appreciate that many examples, variations and alterations to the systems and methods described are within the scope and spirit of the disclosure. Accordingly, the embodiments of the disclosure described are set forth without any loss of generality, and without imposing limitations, on the claims.

The systems and processes disclosed are directed to membrane cryogenic carbon capture and hydrogen recovery. The systems and processes disclosed recover carbon dioxide and hydrogen from the tail gas of a sulfur recovery unit with the carbon dioxide recovered as a liquid and the hydrogen recovered as a gas. The systems and processes disclosed include a first stage membrane unit that is carbon dioxide and hydrogen selective over nitrogen to recover and concentrate carbon dioxide and hydrogen in the permeate. The systems and processes disclosed utilize cryogenic cooling to precipitate carbon dioxide from a stream concentrated with carbon dioxide leaving behind a residue gas stream with higher hydrogen concentration. The systems and processes disclosed include a second stage membrane unit, selective for carbon dioxide over nitrogen and hydrogen, operating on the residue gas from the cryogenic cooler separator. A hydrogen recovery process is positioned downstream of the first stage membrane unit, cryogenic cooling, second stage membrane unit and recovers hydrogen from the retentate stream of the second stage membrane unit. The hydrogen recovery process is any process that can recover and concentrate hydrogen from a gaseous stream rejected from carbon dioxide selective membrane unit. Advantageously, positioning a membrane selective to carbon dioxide and hydrogen over nitrogen upstream of over separation units can increase the effectiveness of those separation units by increasing the concentration of carbon dioxide. Advantageously, the combination of membrane selective to carbon dioxide and hydrogen over nitrogen, cryogenic separation of carbon dioxide, membrane selective to carbon dioxide over hydrogen, and hydrogen recovery process overcomes disadvantages of these systems individually. Advantageously, concentrating the carbon dioxide upstream of the cryogenic separation increases the efficiency of the process such that the pressure and temperature necessary for precipitating carbon dioxide is not wasted on a stream that contains excessive amounts of other components. Advantageously, the membranes used in the membrane cryogenic carbon capture and hydrogen recovery process do not require cryogenic temperatures to operate efficiently and achieve separation of the components. Advantageously, separation of carbon dioxide, hydrogen, and nitrogen can be achieved in membranes above cryogenic operating temperatures due to the use of a carbon dioxide-selective unit that utilize a rubbery membrane. Advantageously, the process and system of the membrane cryogenic carbon capture and hydrogen recovery process facilitate the capture of carbon dioxide regardless of the presence of hydrogen in the tail gas. Advantageously, removing nitrogen in the first stage membrane unit results in higher concentration of carbon dioxide and hydrogen through the remaining part of the process. Advantageously, the processes and systems directed to membrane cryogenic carbon capture and hydrogen recovery can operate the membranes at ambient temperatures efficiently. Advantageously, the reduced amount of hydrogen in the feed to the cryogenic cooling compared to the tail gas stream reduces the amount of power required for the cryogenic cooling. Advantageously, the membrane cryogenic carbon capture and hydrogen recovery process and system enables recovery of carbon dioxide from a diluted source. Advantageously and unexpectedly, the membrane cryogenic carbon capture and hydrogen recovery process and system can handle varying levels of hydrogen without impacting the power demands on the system.

As used in this disclosure, a “membrane” refers to a structure through which mass transfer can occur under a variety of driving forces. The driving forces can be a pressure differential between the two sides of the membrane generated by a positive pressure on the retentate side of the membrane, a vacuum pressure on the permeate side of the membrane, stream component concentration differential between the permeate and retentate sides of the membrane, by sweeping the permeate side of the membrane, or combinations of the same. Driving forces that facilitate the transport of one or more components from the inlet gas stream through the selectively permeable membrane can be pressure, concentration, electrical potentials, or combinations thereof across the membrane. Membrane operation can be in any mode such as high pressure at the retentate side or vacuum pressure on the permeate side. The membrane allows a “penetrant” (a “penetrant” is an entity from a phase in contact with one of the membrane surfaces that passes through the membrane) to pass through the membrane from the retentate into the permeate. As used throughout, the “retentate” is the stream that exits the membrane unit without passing through the membrane, and has been depleted of penetrants. As used throughout, the “permeate” used as a noun can refer to the stream containing penetrants that leaves the membrane unit, or can refer to the liquids and gases that have permeated the membrane of a membrane unit. Permeate can also be used in this disclosure as a verb, and means to spread through or flow through or pass through a membrane of a membrane unit.

As used herein, “glassy membrane” refers to a glassy polymeric membrane. A polymeric membrane is said to be glassy when it operates at a temperature less than its glass transition temperature.

As used herein, “rubbery membrane” refers to a rubbery polymeric membrane. A polymeric membrane is said to be rubbery when it operates at a temperature greater than its glass transition temperature.

As used in this disclosure, the selectivity of a membrane can be expressed as a unitless number for two compounds, shown by X₁/X₂, where X₁ is a first compound and X₂ is a second compound. X₁/X₂ is read as “X₁ over X₂.” Membrane selectivity is the measure of the ability of a membrane to separate two gases, and is a unitless value calculated as the ratio of the gases' permeabilities (or permeances) through the membrane.

As used in this disclosure, a “membrane unit” refers to a manifold assembly containing one or more membranes of the same or different composition to separate the streams of feed, permeate, and retentate. The membrane unit can be any type of membrane unit, including hollow fiber membrane units, plate-and-frame membrane units, spiral wound membrane units, or potted hollow-fiber units. Membranes can be arranged in the membrane unit in a variety of configurations. Membranes can be in a flat-sheet configuration, a plate and frame configuration, or can be arranged to increase packing density, for example in hollow-fiber, capillary, or spirally-wound configurations. Multiple membranes can be utilized in a membrane unit, including composite membranes, membranes made of multiple materials, and different types of membranes placed together in a membrane unit.

Compositions are provided on a dry basis unless otherwise stated.

The description may use the phrases “in some embodiments,” “in an embodiment,” or “in embodiments,” which can each refer to one or more of the same or different embodiments.

As used in this disclosure, the term “about” is utilized to represent the inherent degree of uncertainty that may be attributed to any quantitative comparison, value, measurement, or other representation, and is also utilized in this disclosure to represent the degree by which a quantitative representation can vary from a stated reference without resulting in a change in the basic function of the subject matter at issue.

Referring to FIG. 1, an embodiment of the membrane cryogenic carbon capture and hydrogen recovery process is provided. Tail gas stream 10 is compressed in tail gas compressor 12 to produce compressed tail gas stream 14. Tail gas stream 10 can be diverted from a tail gas treatment unit (not shown) of a sulfur recovery unit (not shown). Tail gas stream 10 can include gases such as hydrogen, argon, nitrogen, helium, carbon monoxide, carbon dioxide, hydrogen sulfide, water vapor, and combinations of the same. The absolute and relative amount of each gas component depend on the efficiency and type of sulfur recovery unit.

Tail gas compressor 12 can be any type of compressor capable of compressing a tail gas stream. Compressed tail gas stream 14 can be at any pressure that is capable to effectively drive carbon dioxide and hydrogen through the membrane and optimize the selectivity of these gases with respect to nitrogen. Compressed vent stream 14 is cooled in cooler 16 to produce cooled vent stream 18.

Cooler 16 can be any type of heat exchanger capable of reducing the temperature of compressed tail gas stream 14. In at least one embodiment, cooler 16 can be a cross exchanger enabling heat exchange between two process streams of the membrane cryogenic carbon capture and hydrogen recovery process. The temperature of a membrane can have an impact on performance and the temperature of cooled vent stream 18 is selected to optimize performance of the selected membrane in first stage membrane unit 24. In at least one embodiment, the temperature of cooled vent stream 18 is between 85° F. and 90° F. (29.4° C. and 32.2° C.). Cooled vent stream 18 is treated in pre-treatment unit 20.

Pre-treatment unit 20 can be any type of unit capable of removing water and sulfur components in cooled vent stream 18. Pre-treatment unit 20 can include molecular sieves and glycol dehydration. Molecular sieves in pre-treatment unit 20 can include 4A, 5A, and combinations of the same. Examples of glycol dehydration include triethylene glycol (TEG) or diethylene glycol (DEG) processes. The dehydrated, substantially free of sulfur stream leaves pre-treatment unit 20 as dry stream 22. Dry stream 22 contains less 250 parts per million (ppm) sulfur. Dry stream 22 is rich in carbon dioxide and is fed to first stage membrane unit 24.

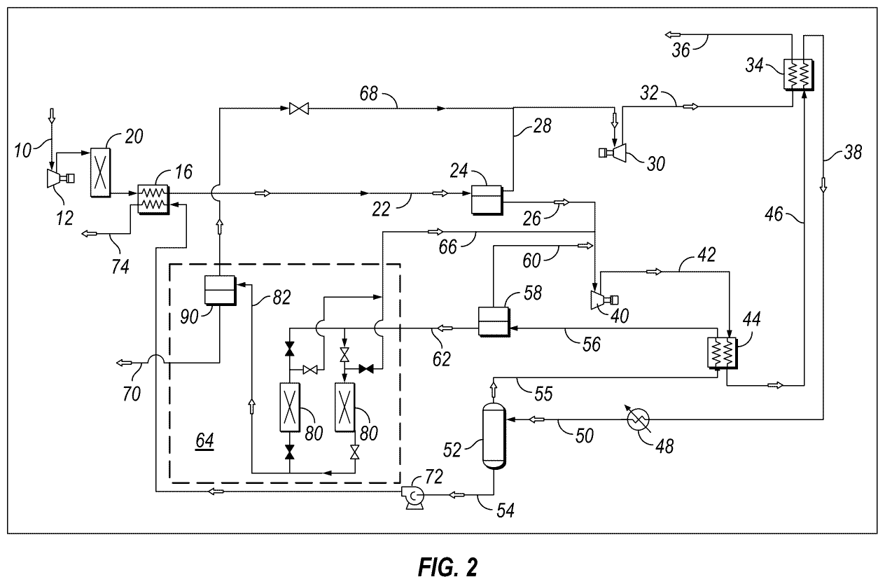

As shown in FIGS. 2-8, in at least one embodiment, pre-treatment unit 20 can be positioned upstream of cooler 16. The purpose of pre-treatment unit 20 and cooler 16 are to remove water and sulfur from tail gas stream 10 and to remove heat due to compression. The order of these two units can be interchanged.

First stage membrane unit 24 can be any type of membrane unit that can include a membrane with selectivity to carbon dioxide and hydrogen over nitrogen and other gases. Preferred membrane selectivity is carbon dioxide/nitrogen >1 and hydrogen/nitrogen>1. Examples of membranes suitable for use in first stage membrane unit 24 include glassy membranes. Examples of glassy membranes include cellulose acetate, polyimides, sulfonated poly phenylene oxide. The membrane in first stage membrane 24 can include a ceramic membrane. In at least one embodiment, first stage membrane unit 24 includes a glassy membrane. The primary purpose of first stage membrane unit 24 is to reject a majority of the nitrogen in tail gas stream 10 and to recover a majority of the carbon dioxide in the permeate. Advantageously, removing nitrogen in first stage membrane unit 24 reduces the volume of the stream to be compressed in compressor 40.

The permeate side of the membrane in first stage membrane unit 24 can operate at 1 psig (108 kPa). The permeate side of the membrane in first stage membrane unit 24 can operate at in vacuum or sweep mode. Carbon dioxide and hydrogen selectively permeate the membrane and are concentrated in the permeate. Nitrogen is rejected by the membrane in first stage membrane unit 24. The retentate side of the membrane in first stage membrane unit 24 operates at the pressure of tail gas compressor 12. First stage membrane unit 24 produces permeate stream 26 and retentate stream 28.

Retentate stream 28 contains those gases which did not permeate the glassy membrane in first stage membrane unit 24, including nitrogen. Retentate stream 28 can flow to turbo-expander 30.

Turbo-expander 30 can be any type of centrifugal or axial-flow turbine through which expansion of gases can occur. The gases in retentate stream 28 can undergo expansion in turbo-expander 30 to produce expanded stream 32. Due to the expansion in turbo-expander 30, the temperature of expanded stream 32 is at cryogenic levels. Cryogenic levels depend on the flow rate, temperature, and composition of the compressed permeate stream 42. The temperature of expanded stream 32 is at a temperature less than 0° C. Expanded stream 32 can be introduced to exhaust exchanger 34.

Exhaust exchanger 34 can be any type of heat exchanger that can exchange heat between two process fluid streams. In at least one embodiment, exhaust exchanger 34 can be a cross exchanger enabling heat exchange between two process streams of the membrane cryogenic carbon capture and hydrogen recovery process. Exhaust exchanger 34 is utilized in economizing the cooling of other process streams to reduce power demand associated with the use of refrigeration cooling. The temperature of expanded stream 32 can be increased in exhaust exchanger 34 to produce exhaust 36. Exhaust 36 exits exhaust exchanger 34 and the membrane cryogenic carbon capture and hydrogen recovery process and system. Exhaust 36 contains primarily nitrogen. Exhaust 36 can contain greater than 90 vol % nitrogen alternately between 90 vol % and 99 vol % nitrogen, alternately between 92 vol % and 97 vol % nitrogen, and alternately between 93 vol % and 96 vol % nitrogen.

Permeate stream 26 can be compressed in compressor 40 to produce compressed permeate stream 42. Compressor 40 can be any type of compressor that can increase the pressure of a gas stream. The pressure of compressed permeate stream 42 is selected to precipitate liquid carbon dioxide when the temperature of the permeate stream is reduced in cryogenic cooler 48. The pressure of compressed permeate stream 42 is greater than the triple point of carbon dioxide, which is 75 psi (517 kPa). Compressed permeate stream 42 can be at a pressure between alternately between 410 psig (2982.2 kPa) and 460 psig (3272.9 kPa), alternately between 425 psig (3031.6 kPa) and 445 psig (3169.5 kPa). In at least one embodiment the pressure of compressed permeate stream 42 is 434 psig (3093.6 kPa).

Compressed permeate stream 42 can be cooled in permeate exchanger 44 to produce cooled permeate stream 46. Permeate exchanger 44 can be any type of heat exchanger capable of reducing the temperature of compressed permeate stream 42. In at least one embodiment, permeate exchanger 44 can be a cross exchanger enabling heat exchange between two process streams of the membrane cryogenic carbon capture and hydrogen recovery process.

The pressure and temperature of cooled permeate stream 46 can be determined based on the content of carbon dioxide in compressed permeate stream 42 to assure precipitation of carbon dioxide at a rate to meet a target carbon recovery in the system.

Cooled permeate stream 46 can be introduced to exhaust exchanger 34. In exhaust exchanger 34, heat is removed from cooled permeate stream 46 to produce cryogenic feed 38. The heat removed from cooled permeate stream 46 enters expanded stream 32 causing the increase in temperature to produce exhaust 36. Both permeate exchanger 44 and exhaust exchanger 34 act as pre-coolers to reduce the load on cryogenic cooler 48. The temperature of cryogenic feed 38 can be between −18° F. and −10° F. (−27.7° C. and −12.2° C.) and alternately between −16° C. and −13° C. (−26.7° C. and −25° C.). Cryogenic feed 38 is cooled in cryogenic cooler 48.

Cryogenic cooler 48 can be any type of cryogenic cooling unit capable of reducing the temperature of a gas stream to a temperature at which liquid carbon dioxide can precipitate when under pressure. The conditions in compressor 40 and cryogenic cooler 48 can be designed together to induce carbon dioxide precipitation downstream of cryogenic cooler 48. Cryogenic cooler 48 reduces the temperature of cryogenic feed 38 to produce cryogenic stream 50. The temperature of cryogenic stream 50 is greater than −56° C. to avoid reaching the point at which carbon dioxide solidifies.

Cryogenic stream 50 is introduced to knock-out drum 52. Knock-out drum 52 can be any type of separation drum that allows the carbon dioxide to precipitate. Knock-out drum 52 is at the same temperature and pressure conditions as cryogenic stream 50 to maintain the carbon dioxide in liquid form. The precipitated carbon dioxide exits the knock-out drum as liquid carbon dioxide 54. Advantageously, cryogenic cooler 48 and knock-out drum 52 enables recovery of carbon dioxide at low pressures and further concentrates hydrogen in the separated gas. Liquid carbon dioxide 54 can be used as a heat transfer medium in the process or can be injected into a ground formation after its pressure boosted. The pressure of liquid carbon dioxide 54 is increased to avoid the vaporization of carbon dioxide. Using the liquid carbon dioxide as a heat transfer medium can economize the cooling of other streams in the membrane cryogenic carbon capture and hydrogen recovery process. Gases in cryogenic stream 50 separate from carbon dioxide in knock-out drum 52 and exit as membrane feed 56.

Membrane feed 56 can be introduced to second stage membrane unit 58. Second stage membrane unit 58 can be any type of membrane unit capable of concentrating hydrogen separate from carbon dioxide. Second stage membrane unit 58 can include a rubbery membrane that is selective to carbon dioxide over hydrogen and nitrogen. Preferred membrane selectivity is carbon dioxide/nitrogen >1 and carbon dioxide/hydrogen >1. Examples of rubbery membranes include polyamide-polyether and polymethylsiloxane. An example of a polyamide-polyether compound is PEBAX®. The permeate side of the rubbery membrane in second stage membrane unit 58 can operate at 1 psig (108 kPa). The permeate side of second stage membrane unit 58 can operate in vacuum or in sweep mode. Carbon dioxide permeates the rubbery membrane and is concentrated in the permeate. Hydrogen and nitrogen are rejected by the rubbery membrane. The retentate side of the rubbery membrane operates at the pressure of compressor 40. Second stage membrane unit 58 produces rubbery membrane permeate 60 and rubbery membrane retentate 62. Rubbery membrane permeate 60 can be mixed with permeate stream 26 and is recycled through cryogenic cooler 48 and knock-out drum 52 to capture additional carbon dioxide.

The size of the membrane in second stage membrane unit 58 can be selected based on the units and process of the hydrogen recovery process. For example, if the hydrogen recovery process includes systems designed to separate and recover carbon dioxide, the size of the membrane can be reduced. If the hydrogen recovery process does not include such systems, the membrane can be sized to reduce the amount of carbon dioxide that is rejected to minimize the amount of carbon dioxide that is introduced to the hydrogen recovery process.

Rubbery membrane retentate 62 is directed to hydrogen recovery process 64. Rubbery membrane retentate 62 contains those gases which did not permeate the rubbery membrane in second stage membrane unit 58, including hydrogen, nitrogen, carbon dioxide, and combinations of the same.

Hydrogen recovery process 64 can include one or more systems or units capable of separating and recovering hydrogen. Hydrogen recovery process 64 both increases recovery of carbon dioxide and separate of nitrogen, but in doing so it improves the quality of the hydrogen product stream. Hydrogen recovery process 64 can include an amine removal process for removing carbon dioxide, gas separation membranes, an adsorption process, a molecular centrifuge, and combinations of the same. The adsorption process in hydrogen recovery process 64 can be selected from a pressure swing adsorption process, a temperature swing adsorption process, or combinations of the same. The adsorption process in hydrogen recovery process 64 can be selective to carbon dioxide or nitrogen and rejective to hydrogen. Hydrogen recovery process can separate hydrogen and carbon dioxide and can recycle these streams back into the process. Hydrogen recovery process 64 can produce hydrogen product stream 70 which contains hydrogen. In embodiments where hydrogen recovery process 64 includes a glassy membrane it is noted that while such membranes have efficient selectivity for hydrogen over nitrogen, the selectivity of hydrogen over carbon dioxide is usually low. Therefore, when hydrogen recovery process 64 includes glassy membrane, the carbon dioxide level in the feed stream to the glassy membrane should be reduced by oversizing the rubbery membrane in the second stage membrane unit, alternately including a carbon dioxide adsorption process in the hydrogen recovery process, alternately including an amine process to remove carbon dioxide, or combinations of the same. When hydrogen recovery process 64 includes units for separating carbon dioxide, hydrogen recovery process 64 can optionally produce carbon dioxide rich stream 66 which contains carbon dioxide and can be mixed with rubbery membrane permeate and recycled to cryogenic cooler 48 and knock-out drum 52 to capture additional carbon dioxide. Hydrogen recovery process 64 can produce carbon dioxide lean stream 68 that contains gas components that are to be removed from the process, including nitrogen, argon, helium, residual amounts of hydrogen, carbon dioxide, carbon monoxide, hydrogen sulfide, water vapor, and combinations of the same. Carbon dioxide lean stream 68 can optionally be mixed with dry stream 22 upstream of first stage membrane unit 24, alternately can optionally be mixed with retentate stream 28 upstream of turbo-expander 30, and alternately can optionally be mixed with exhaust 36. The determination to recycle the stream in the system may depend on the composition carbon dioxide lean stream 68 and any process advantages.

Hydrogen product 70 can contain greater than 85 vol % hydrogen, alternately greater than 90 vol % hydrogen, and alternately between 90 vol % and 99 vol % hydrogen.

In at least one embodiment, described with reference to FIG. 2, hydrogen recovery process 64 can include pressure swing adsorption unit 80 and hydrogen recovery membrane 90.

Pressure swing adsorption unit 80 produces carbon dioxide depleted stream 82 during the adsorption cycle, the high pressure operation. Carbon dioxide is adsorbed during the high pressure operation allowing the other gases to flow from pressure swing adsorption unit 80 as carbon dioxide depleted stream 82. During the regeneration/desorption cycle, low pressure operation occurs which causes the adsorbed carbon dioxide to desorb and carbon dioxide rich stream 66 is produced which contains the recovered carbon dioxide.

Carbon dioxide depleted stream 82 is introduced to hydrogen recovery membrane 90. Carbon dioxide depleted stream 82 contains hydrogen and nitrogen and residual amounts of carbon dioxide. The main objective of hydrogen recovery membrane 90 is to recover hydrogen and concentrate it in hydrogen product stream 70. Hydrogen recovery membrane 90 can include any gas separation membrane selective for hydrogen over nitrogen. In at least one embodiment, hydrogen recovery membrane 90 includes the same glassy membrane as included in first stage membrane unit 24. The permeate side of hydrogen recovery membrane 90 can operate at 1 psig (108 kPa). The permeate side of hydrogen recovery membrane 90 can operate in vacuum or sweep mode. Hydrogen permeates the membrane and is concentrated in the permeate. Nitrogen is rejected by the membrane. Hydrogen recovery membrane 90 produces hydrogen product 70 and carbon dioxide lean stream 68.

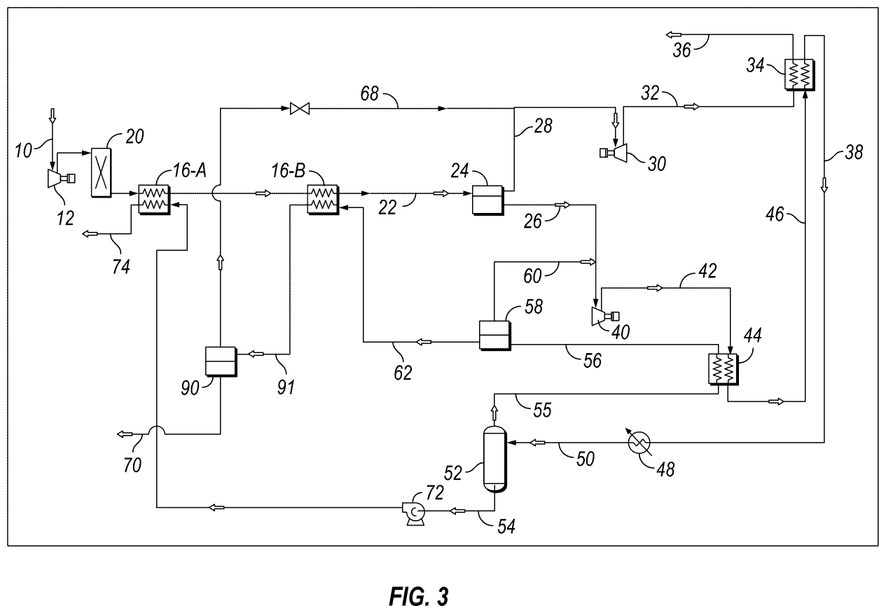

In at least one embodiment, described with reference to FIG. 2 and FIG. 3, hydrogen recovery process 64 can include one hydrogen recovery membrane 90. In the process and system containing only one hydrogen recovery membrane 90, the membrane in second stage membrane unit 58 can be sized to maximize the amount of carbon dioxide that permeates the membrane to minimize the amount of carbon dioxide that is introduced to hydrogen recovery process 64.

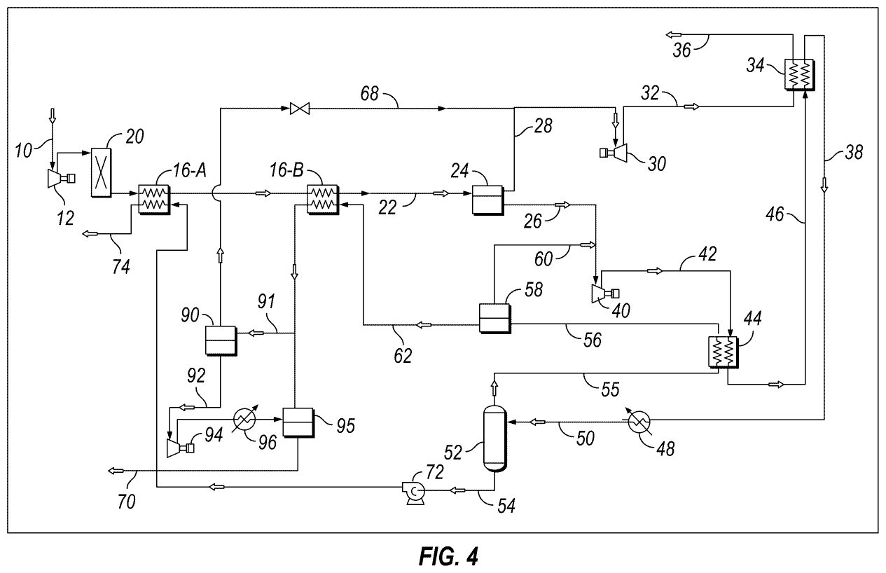

In at least one embodiment, described with reference to FIG. 2 and FIG. 4, hydrogen recovery process 64 can include two hydrogen selective membrane units, hydrogen recovery membrane 90 and hydrogen selective membrane 95. In this embodiment of hydrogen recovery process 64, the membranes work on recovering and concentrating hydrogen in the permeate of hydrogen selective membrane 95. In at least one embodiment, hydrogen recovery membrane 90 and hydrogen selective membrane 95 includes the same glassy membrane as used in first stage membrane unit 24. The permeate side of hydrogen recovery membrane 90 and hydrogen selective membrane 95 can operate at 1 psig (108 kPa). The permeate side of hydrogen recovery membrane 90 and permeate side of hydrogen selective membrane 95 can operate in vacuum or sweep mode. Hydrogen permeates the membrane in each of hydrogen recovery membrane 90 and hydrogen selective membrane 95 and is concentrated in the permeate. Nitrogen is rejected by the membrane of each. Hydrogen recovery membrane 90 produces carbon dioxide lean stream 68 and inter-stage permeate 92. Inter-stage permeate 92 can be compressed in inter-stage compressor 94 and cooled in inter-stage cooler 96 as needed to adjust the operating parameters to maximize separation in hydrogen selective membrane 95.

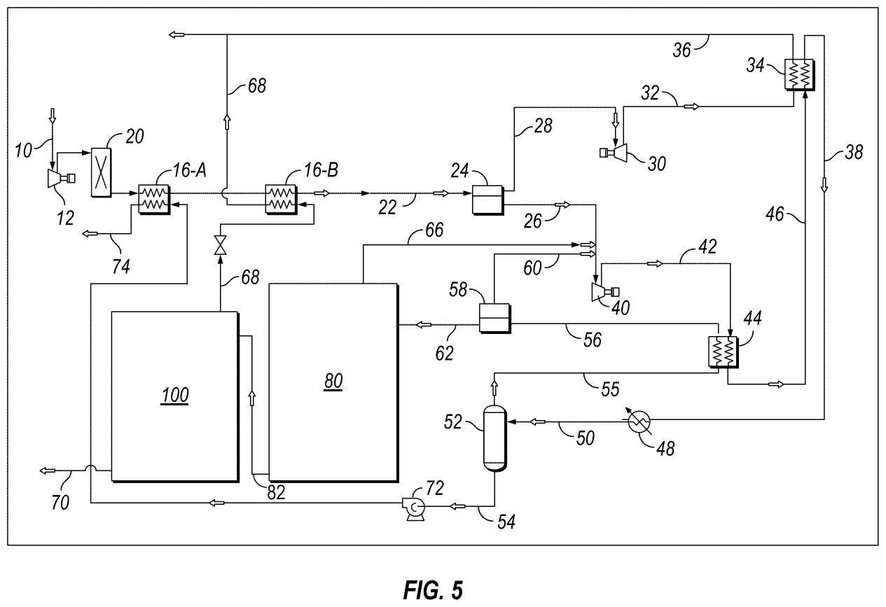

In at least one embodiment, described with reference to FIG. 2 and FIG. 5, hydrogen recovery process 64 includes two adsorption based processes, one is a carbon dioxide adsorption and one is a nitrogen adsorption process. The feed to the nitrogen adsorption process is the carbon dioxide depleted stream from the carbon dioxide adsorption process. In at least one embodiment, the carbon dioxide adsorption process can be a pressure swing adsorption unit. In at least one embodiment, the nitrogen adsorption process be a nitrogen pressure swing adsorption unit. In the embodiment described with reference to FIG. 5, carbon dioxide depleted stream 82 from pressure swing adsorption unit 80 is the feed to nitrogen pressure swing adsorption 100. In a high-pressure cycle of nitrogen pressure swing adsorption unit 100, nitrogen is adsorbed and retained with the bed, while hydrogen elutes out as hydrogen product stream 70. The impurities present in carbon dioxide depleted stream 82, including carbon monoxide and argon, can be adsorbed in part and can elute out as part of the high pressure stream. During a low-pressure cycle nitrogen is desorbed and collected and exits nitrogen pressure swing adsorption unit 100 as carbon dioxide lean stream 68. Pressure swing adsorption unit 100 is regenerated during the low-pressure cycle. Advantageously, maintain a separate carbon dioxide adsorption process and nitrogen adsorption process can maximize the hydrogen and carbon dioxide recovery and reduce looping of non-condensable gases like nitrogen.

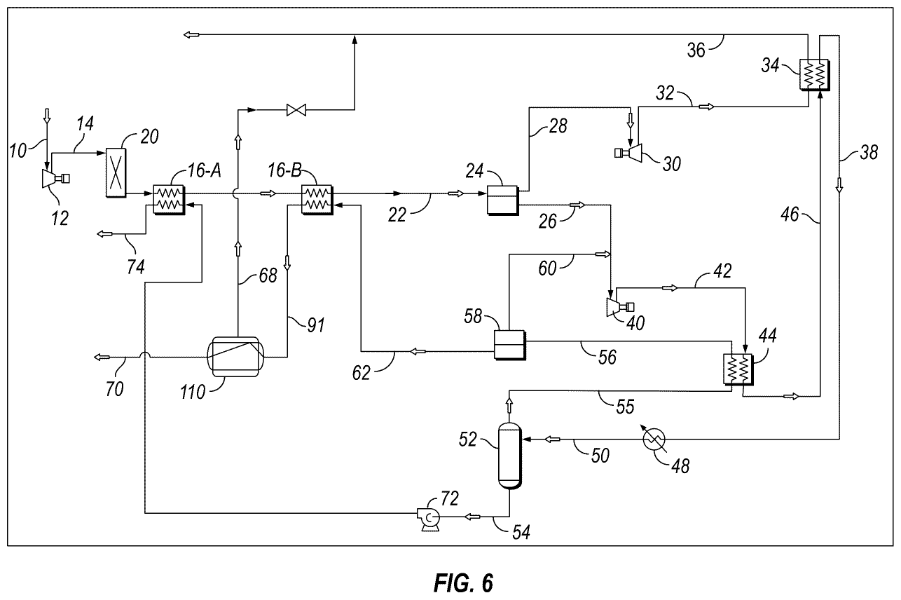

In at least one embodiment, described with reference to FIG. 6, hydrogen recovery process 64 includes a molecular centrifuge unit. Molecular centrifuge unit 110 can be any type of molecular centrifuge that operates by separating components based on molecular weight. Molecular centrifuge unit 110 can include one or more stages. Molecular centrifuge unit 110 separates rubbery membrane retentate 62 to produce hydrogen product stream 70 and carbon dioxide lean stream 68.

As described with reference to FIGS. 2-4, carbon dioxide lean stream 68 can be mixed with retentate stream 28, bypassing first stage membrane unit 24. As described with reference to FIGS. 5 and 6, carbon dioxide lean stream 68 can be mixed with exhaust 36.

### EXAMPLES

Computer simulations were performed to illustrate the operation and results of the processes disclosed herein. In each simulation, pre-treatment unit 20 was simulated as a molecular sieve A4. The membranes selected for each membrane were simulated with the selectivity valves shown in Table 1.

TABLE 1
Selectivity for membranes used in Examples 1-6

| | Glassy Membrane | Rubbery Membrane | Glassy Membrane |
|---|---|---|---|
| | Nitrogen Rejective | Nitrogen Hydrogen | Nitrogen Rejective |
| | Membrane | Rejective Membrane | Membrane |
| | CO₂ = 25 GPU | CO₂ = 25 GPU | H₂ = 100 GPU |
| Gas | CO₂/Gas | CO₂/Gas | H₂/Gas |
| Hydrogen | 0.25 | 10.0 | 1 |
| Argon | 13.7 | 28.6 | 54.8 |
| Nitrogen | 33.475 | 40.3 | 133.9 |
| CO | 13.7 | 30.0 | 54.8 |
| CO₂ | 1 | 1.0 | 4 |
| H₂S | 1 | 0.29 | 4 |
| H₂O | 0.118 | 0.29 | 0.472 |

The selectivity values for the glassy membrane are typical of a polyimide based membrane, such as Matrimid® 5218 from Huntsman, at around 86° F. The selectivity values for the rubbery membrane are consistent with a Polaris™ type membrane from Membrane Technology and Research, Inc.

The examples below illustrate the effect of different configurations in the hydrogen recovery process.

Example 1. Example 1 is directed to an embodiment of the membrane carbon capture and hydrogen recovery process using a simulation program. In this example, the hydrogen recovery process includes a pressure swing absorption and membrane unit. A simplified depiction of the process layout used in the simulation is shown in FIG. 2.

Permeate stream 26, carbon dioxide rich stream 66 from pressure swing adsorption unit 80 of hydrogen recovery process 64, and rubbery membrane retentate 62 are consolidated in one stream. The consolidated stream is concentrated in carbon dioxide and hydrogen, containing about 73.7% CO₂ and 7.77% H₂.

Cryogenic stream 50 is separated in knock-out drum 52, where precipitated liquid carbon dioxide is separated as liquid carbon dioxide 54 with a purity of about 97.5% CO₂. The pressure of liquid carbon dioxide 54 is boosted to 2200 psig (15269.8 kPa) via liquid pump 72 and can be used as the cooling fluid in cooler 16.

Overhead gas stream 55 from knock-out drum 52 is preheated to about 80° F. (26.7° F.) to produce membrane feed 56 to second stage membrane unit 58. Membrane feed 56 is concentrated with hydrogen, containing about 17.7% hydrogen after precipitating carbon dioxide in knock-out drum 52.

Hydrogen recovery process 64 in Example 1 includes pressure swing adsorption unit 80 and hydrogen recovery membrane 90. Hydrogen recovery membrane 90 was simulated as having a glassy membrane having the selectivities defined in Table 1. This glassy membrane was selected because it possesses high selectivity for hydrogen over nitrogen. Hydrogen product stream 70 contains about 90% of the hydrogen that was in tail gas stream 10 at 91% purity. Carbon dioxide lean stream 68 contains about 94.7% nitrogen at pressure of 400 psig (2859 kPa). Carbon dioxide lean stream 68 can be mixed with retentate stream 28.

Table 2 provides the area of each membrane relative to the area required by the glassy membrane in first stage membrane unit 24. In addition, Table 2 provides the electrical power required.

TABLE 2
Performance parameters and recovery data
of Example 1.
Membrane Size (Area index %)

| | |
|---|---|
| Glassy Membrane in First Stage Membrane | 100 |
| Unit 24 | |
| Rubbery Membrane in Second Stage | 0.7 |
| Membrane Unit 58 | |
| Glassy Membrane in Hydrogen Recovery | 2.1 |
| Membrane 90 | |

Electrical Requirements in Process Drives (MW)

| | |
|---|---|
| Tail Gas Compressor 12 | 8.62 |
| Compressor 40 | 3.75 |
| Cryogenic Cooler 48 | 1.02 |
| Liquid Pump 72 | 0.11 |
| Turbo-expander 30 | −1.93 |
| Total electrical power required (MW) | 11.57 |

CO₂ and H₂ Recovery % (Purity %)

| | |
|---|---|
| Liquid carbon dioxide 54 | 90.1 (97.8) |
| Hydrogen product stream 70 | 89.7 (91.8) |

Table 3 provides the results and material balance of the streams of Example 1.

TABLE 3
Example 1 stream material balance.

| Stream | 10 | 22 | 28 | 26 | 38 | 54 | 56 | 60 |
|---|---|---|---|---|---|---|---|---|
| Temperature, ° C. | 48.9 | 30 | 25 | 25 | −25 | −37.8 | 26.7 | 13.3 |
| Pressure, psig | 2 | 300 | 300 | 1 | 434 | 434 | 434 | 1 |
| Flow, MMSCFD | 56.7 | 51.0 | 34.5 | 16.5 | 20.6 | 11.8 | 8.8 | 3.1 |

Component, vol %

| | | | | | | | | |
|---|---|---|---|---|---|---|---|---|
| Hydrogen | 2.40 | 2.67 | 0.00 | 8.28 | 7.77 | 0.25 | 17.90 | 7.22 |
| Argon | 0.72 | 0.80 | 0.93 | 0.53 | 0.45 | 0.10 | 0.91 | 0.14 |
| Nitrogen | 64.36 | 71.60 | 95.50 | 21.23 | 17.81 | 2.08 | 38.99 | 4.17 |
| CO | 0.02 | 0.02 | 0.03 | 0.01 | 0.27 | 0.02 | 0.61 | 0.09 |
| CO₂ | 22.40 | 24.91 | 3.54 | 69.95 | 73.70 | 97.55 | 41.58 | 88.39 |
| H₂S | 200 ppm | <20 ppm | <20 ppm | <20 ppm | <20 ppm | <20 ppm | <20 ppm | <20 ppm |
| H₂O | 10.08 | <20 ppm | <20 ppm | <20 ppm | <20 ppm | <20 ppm | <20 ppm | <20 ppm |

| Stream | 62 | 66 | 82 | 70 | 68 | 36 | 74 |
|---|---|---|---|---|---|---|---|
| Temperature, ° C. | 17.2 | 0 | 0 | 0 | 0 | 21.1 | 8.9 |
| Pressure, psig | 434 | 35 | 400 | 1 | 400 | 1 | 2200 |
| Flow, MMSCFD | 5.7 | 1.0 | 4.7 | 1.3 | 3.3 | 37.9 | 11.8 |

Component, vol %

| | | | | | | | |
|---|---|---|---|---|---|---|---|
| Hydrogen | 23.66 | 1.32 | 28.54 | 91.78 | 3.09 | 0.27 | 0.25 |
| Argon | 1.33 | 0.07 | 1.61 | 0.40 | 2.09 | 1.03 | 0.10 |
| Nitrogen | 57.75 | 3.22 | 69.65 | 7.42 | 94.70 | 95.44 | 2.08 |
| CO | 0.89 | 4.97 | 0.00 | 0.00 | 0.00 | 0.02 | 0.02 |
| CO₂ | 16.37 | 90.41 | 0.20 | 0.40 | 0.12 | 3.23 | 97.55 |
| H₂S | <20 ppm | <20 ppm | <20 ppm | <20 ppm | <20 ppm | <20 ppm | <20 ppm |
| H₂O | <20 ppm | <20 ppm | <20 ppm | <20 ppm | <20 ppm | <20 ppm | <20 ppm |

The hydrogen recovery process includes a pressure swing adsorption unit because the rubbery membrane reject included substantial levels of carbon dioxide. The hydrogen recovery process of this example can recovery both carbon dioxide and hydrogen.

Example 2. Example 2 is a simulation of an embodiment of the membrane carbon capture and hydrogen recovery process, where the hydrogen recovery process included one hydrogen recovery membrane. FIG. 3 is a simplified depiction of the process layout used in the simulation.

Hydrogen recovery process 64 includes hydrogen recovery membrane 90. Hydrogen recovery membrane 90 included the glassy membrane used in Example 1 with the selectivity defined in Table 1. First stage membrane unit 24 also included the glassy membrane used in Example 1. Second stage membrane unit 58 was simulated with the same rubbery membrane selectivities as used in Example 1. Rubbery membrane retentate 62 is pre-heated through exchange with second cooler 16-B to produce pre-heated retentate 91 before being introduced to hydrogen recovery membrane 90. Table 4 provides the area of each membrane relative to the area required by the glassy membrane in first stage membrane unit 24.

TABLE 4
Performance parameters and recovery data of Example 2.
Membrane Size (Area index %)

| | |
|---|---|
| Glassy Membrane in First Stage Membrane Unit 24 | 100 |
| Rubbery Membrane in Second Stage Membrane Unit 58 | 2.5 |
| Glassy Membrane in Hydrogen Recovery Membrane 90 | 2.0 |

Process Electrical Drives (MW)

| | |
|---|---|
| Tail Gas Compressor 12 | 8.62 |
| Compressor 40 | 4.15 |
| Cryogenic Cooler 48 | 1.00 |
| Liquid Pump 72 | 0.11 |
| Turbo-expander 30 | −1.92 |
| Total electrical power required (MW) | 11.97 |

CO₂ and H₂ Recovery % (Purity %)

| | |
|---|---|
| Liquid carbon dioxide 54 | 90.8 |
| | (97.7) |
| Hydrogen product stream 70 | 90.8 |
| | (90.2) |

The size of the rubbery membrane in second stage membrane unit 58 increased by 2.5% in order to reduce the concentration of carbon dioxide down to 0.9% in rubbery membrane retentate 62. As a consequence, the size of rubbery membrane permeate 60 increased. Additionally, the size and power demand of compressor 40 increased by about 0.4 MW compared to Example 1. The results and material balance of the streams are shown in Table 5.

TABLE 5
Material balance of streams of Example 2.

| Stream | 10 | 22 | 28 | 26 | 38 | 54 | 56 |
|---|---|---|---|---|---|---|---|
| Temperature, ° C. | 48.9 | 30 | 25 | 25 | −26.7 | −37.8 | 26.7 |
| Pressure, psig | 2 | 300 | 300 | 1 | 434 | 434 | 434 |
| Flow, MMSCFD | 56.7 | 51.0 | 34.4 | 16.6 | 22.8 | 11.8 | 11.0 |

Component, vol %

| Hydrogen | 2.40 | 2.67 | 0.00 | 8.21 | 10.82 | 0.31 | 22.11 |
|---|---|---|---|---|---|---|---|
| Argon | 0.72 | 0.80 | 0.93 | 0.53 | 0.47 | 0.09 | 0.87 |
| Nitrogen | 64.36 | 71.60 | 95.65 | 21.52 | 18.13 | 1.88 | 35.57 |
| CO | 0.02 | 0.02 | 0.03 | 0.02 | 0.01 | 0.00 | 0.03 |
| CO₂ | 22.40 | 24.91 | 3.39 | 69.73 | 70.56 | 97.72 | 41.42 |
| H₂S | 200 ppm | <20 ppm | <20 ppm | <20 ppm | <20 ppm | <20 ppm | <20 ppm |
| H₂O | 10.08 | <20 ppm | <20 ppm | <20 ppm | <20 ppm | <20 ppm | <20 ppm |
| Stream | 60 | 62 | 91 | 70 | 68 | 36 | 74 |
| Temperature, ° F. | 13.3 | 17.8 | 30 | 30 | 28.4 | 24.4 | 8.9 |
| Pressure, psig | 1 | 434 | 434 | 1 | 300 | 1 | 2200 |
| Flow, MMSCFD | 6.2 | 4.8 | 4.8 | 1.3 | 3.5 | 37.9 | 11.8 |

Component, vol %

| | | | | | | | |
|---|---|---|---|---|---|---|---|
| Hydrogen | 17.83 | 27.62 | 27.62 | 90.25 | 3.84 | 0.35 | 0.31 |
| Argon | 0.3 | 1.61 | 1.61 | 0.41 | 2.07 | 1.03 | 0.09 |
| Nitrogen | 9.05 | 69.78 | 69.78 | 7.44 | 93.54 | 95.45 | 1.88 |
| CO | 0.01 | 0.05 | 0.05 | 0.01 | 0.06 | 0.03 | 0.00 |
| CO₂ | 72.81 | 0.94 | 0.94 | 1.89 | 0.5 | 3.13 | 97.72 |
| H₂S | <20 ppm | <20 ppm | <20 ppm | <20 ppm | <20 ppm | <20 ppm | <20 ppm |
| H₂O | <20 ppm | <20 ppm | <20 ppm | <20 ppm | <20 ppm | <20 ppm | <20 ppm |

Example 3. Example 3 was a simulation of an embodiment of the membrane carbon capture and hydrogen recovery process, where the hydrogen recovery process included two membrane units. FIG. 4 is a simplified depiction of the process layout used in the simulation.

Hydrogen recovery process 64 includes a two-stage hydrogen recovery membrane unit. Hydrogen recovery membrane 90 and hydrogen selective membrane 95. Both hydrogen recovery membrane 90 and hydrogen selective membrane 95 were simulated with glassy membranes having the selectivity values from Table 1. First stage membrane unit 24 also included the glassy membrane used in Example 1. Second stage membrane unit 58 used the rubbery membrane used in Example 1. Table 6 provides the area of each membrane relative to the area required by the glassy membrane in first stage membrane unit 24.

TABLE 6
Performance parameters and recovery data of Example 3.
Membrane Size (Area index %)

| | |
|---|---|
| Glassy Membrane in First Stage Membrane Unit 24 | 100 |
| Rubbery Membrane in Second Stage | 2.5 |
| Membrane Unit 58 | |
| Combined size of Glassy Membrane in Hydrogen | 2.2 |
| Recovery | |
| Membrane 90 and Hydrogen Selective Membrane 95 | |

Process Electrical Drives (MW)

| | |
|---|---|
| Tail Gas Compressor 12 | 8.62 |
| Compressor 40 | 4.15 |
| Inter-stage compressor 94 | 0.38 |
| Cryogenic Cooler 48 | 1.00 |
| Liquid Pump 72 | 0.11 |
| Turbo-expander 30 | −1.92 |
| Total electrical power required (MW) | 12.34 |

CO₂ and H₂ Recovery % (Purity %)

| | |
|---|---|
| Liquid carbon dioxide 54 | 90.8 |
| | (97.7) |
| Hydrogen product stream 70 | 87.2 |
| | (99.0) |

Looking at Table 6, the overall power demand has increased compared to Example 2 to meet the power demand of inter-stage compressor 94 in hydrogen recovery process 64. The size of the hydrogen recovery process increased by about 0.2% compared to the size of the hydrogen recovery membrane process in example 1. Hydrogen product stream 70 has increased purity compared to Example 1 or Example 2. The results and material balance of the streams are shown in Table 7.

TABLE 7
Material balance of streams of Example 3.

| Stream | 10 | 22 | 28 | 26 | 38 | 54 | 56 | 60 |
|---|---|---|---|---|---|---|---|---|
| Temperature, C. | 48.9 | 30 | 30 | 30 | 26.7 | 37.8 | 26.7 | 13.3 |
| Pressure, psig | 2 | 300 | 300 | 1 | 434 | 434 | 434 | 1 |
| Flow, MMSCFD | 56.7 | 51.0 | 34.4 | 16.6 | 22.8 | 11.8 | 11.0 | 6.2 |

Component, vol %

| | | | | | | | | |
|---|---|---|---|---|---|---|---|---|
| Hydrogen | 2.40 | 2.67 | 0.00 | 8.21 | 10.82 | 0.31 | 22.11 | 17.83 |
| Argon | 0.72 | 0.80 | 0.93 | 0.53 | 0.47 | 0.09 | 0.87 | 0.3 |
| Nitrogen | 64.36 | 71.60 | 95.65 | 21.52 | 18.13 | 1.88 | 35.57 | 9.05 |
| CO | 0.02 | 0.02 | 0.03 | 0.02 | 0.01 | 0.00 | 0.03 | 0.01 |
| CO₂ | 22.40 | 24.91 | 3.39 | 69.73 | 70.56 | 97.72 | 41.42 | 72.81 |
| H₂S | 200 ppm | <20 ppm | <20 ppm | <20 ppm | <20 ppm | <20 ppm | <20 ppm | <20 ppm |
| H₂O | 10.08 | <20 ppm | <20 ppm | <20 ppm | <20 ppm | <20 ppm | <20 ppm | <20 ppm |

| Stream | 62 | 91 | 92 | 70 | 68 | 36 | 74 |
|---|---|---|---|---|---|---|---|
| Temperature, C. | 17.8 | 30 | 30 | 30.1 | 28.4 | 24.4 | 8.9 |
| Pressure, psig | 434 | 434 | 1 | 1 | 300 | 1 | 2200 |
| Flow, MMSCFD | 4.8 | 5.6 | 1.94 | 1.2 | 3.6 | 38.0 | 11.8 |

Component, vol %

| | | | | | | | |
|---|---|---|---|---|---|---|---|
| Hydrogen | 27.62 | 38.84 | 92.43 | 99.00 | 3.65 | 0.35 | 0.31 |
| Argon | 1.61 | 1.49 | 0.29 | 0.01 | 2.15 | 1.05 | 0.09 |
| Nitrogen | 69.78 | 62.2 | 5.0 | 0.07 | 93.17 | 95.41 | 1.88 |
| CO | 0.05 | 0.05 | 0.01 | 0.00 | 0.07 | 0.03 | 0.00 |
| CO₂ | 0.94 | 1.42 | 2.27 | 0.89 | 0.96 | 3.16 | 97.72 |
| H₂S | <20 ppm | <20 ppm | <20 ppm | <20 ppm | <20 ppm | <20 ppm | <20 ppm |
| H₂O | <20 ppm | <20 ppm | <20 ppm | <20 ppm | <20 ppm | <20 ppm | <20 ppm |

Example 4. Example 4 was a simulation of an embodiment of the membrane carbon capture and hydrogen recovery process according to FIG. 5. FIG. 5 is a simplified depiction of the process layout used in the simulation. In this example, the hydrogen recovery process included two PSA units.

Hydrogen recovery process 64 was simulated to include pressure swing adsorption unit 80 and nitrogen pressure swing adsorption unit 100. Pressure swing adsorption unit 80 operates as described with reference to Example 1 to concentrate carbon dioxide. Nitrogen pressure swing adsorption unit 100 operates to concentrate nitrogen and in doing so separates hydrogen. Table 8 provides the area of each membrane relative to the area required by the glassy membrane in first stage membrane unit 24.

TABLE 8
Performance parameters and recovery data of Example 4.
Membrane Size (Area index %)

| | |
|---|---|
| Glassy Membrane in First Stage Membrane | 100 |
| Unit 24 | |
| Rubbery Membrane in Second Stage | 0.7 |
| Membrane Unit 58 | |

Process Electrical Drives (MW)

| | |
|---|---|
| Tail Gas Compressor 12 | 8.62 |
| Compressor 40 | 3.75 |
| Cryogenic Cooler 48 | 1.15 |
| Liquid Pump 72 | 0.11 |
| Turbo-expander 30 | −1.78 |
| Total electrical power required (MW) | 11.85 |

CO₂ and H₂ Recovery % (Purity %)

| | |
|---|---|
| Liquid carbon dioxide 54 | 90.7 |
| | (97.6) |
| Hydrogen product stream 70 | 87.9 |
| | (99.6) |

The results and material balance of the streams are shown in Table 9.

TABLE 9
Material balance of streams of Example 4.

| Stream | 10 | 22 | 28 | 26 | 38 | 54 | 56 |
|---|---|---|---|---|---|---|---|
| Temperature, ° C. | 48.9 | 30 | 30 | 30 | −25 | −37.8 | 26.7 |
| Pressure, psig | 2 | 300 | 300 | 1 | 434 | 434 | 434 |
| Flow, MMSCFD | 56.7 | 51.0 | 34.5 | 16.5 | 20.6 | 11.8 | 8.8 |

Component, vol %

| Hydrogen | 2.40 | 2.67 | 0.00 | 8.28 | 7.77 | 0.25 | 17.90 |
|---|---|---|---|---|---|---|---|
| Argon | 0.72 | 0.80 | 0.93 | 0.53 | 0.45 | 0.10 | 0.91 |
| Nitrogen | 64.36 | 71.60 | 95.50 | 21.23 | 17.81 | 2.08 | 38.99 |
| CO | 0.02 | 0.02 | 0.03 | 0.01 | 0.27 | 0.02 | 0.61 |
| CO₂ | 22.40 | 24.91 | 3.54 | 69.95 | 73.70 | 97.55 | 41.58 |
| H₂S | 200 ppm | <20 ppm | <20 ppm | <20 ppm | <20 ppm | <20 ppm | <20 ppm |
| H₂O | 10.08 | <20 ppm | <20 ppm | <20 ppm | <20 ppm | <20 ppm | <20 ppm |
| Stream | 60 | 62 | 66 | 68 | 70 | 36 | 74 |
| Temperature, ° C. | 13.3 | 17.8 | 0 | 0 | 0 | 24.4 | 8.9 |
| Pressure, psig | 1 | 434 | 35 | 25 | 350 | 1 | 2200 |
| Flow, MMSCFD | 3.1 | 5.7 | 1.0 | 3.4 | 1.2 | 38.0 | 11.8 |

Component, vol %

| | | | | | | | |
|---|---|---|---|---|---|---|---|
| Hydrogen | 7.22 | 23.66 | 1.32 | 3.10 | 99.67 | 0.28 | 0.25 |
| Argon | 0.14 | 1.33 | 0.07 | 2.16 | 0.06 | 1.04 | 0.10 |
| Nitrogen | 4.17 | 57.75 | 3.22 | 94.47 | 0.26 | 95.41 | 2.08 |
| CO | 0.09 | 0.89 | 4.97 | 0.00 | 0.00 | 0.02 | 0.02 |
| CO₂ | 88.39 | 16.37 | 90.41 | 0.27 | 0.40 | 3.24 | 97.55 |
| H₂S | <20 ppm | <20 ppm | <20 ppm | <20 ppm | <20 ppm | <20 ppm | <20 ppm |
| H₂O | <20 ppm | <20 ppm | <20 ppm | <20 ppm | <20 ppm | <20 ppm | <20 ppm |

Example 5. Example 5 was a simulation of an embodiment of the membrane carbon capture and hydrogen recovery process, where the hydrogen recovery process included a molecular centrifuge. FIG. 6 is a simplified depiction of the process layout used in the simulation.

Hydrogen recovery process 64 was simulated to molecular centrifuge 110. The feed to molecular centrifuge 110 is rubbery membrane retentate 62. Table 10 provides the area of each membrane relative to the area required by the glassy membrane in first stage membrane unit 24.

TABLE 10
Performance parameters and recovery data of Example 5.
Membrane Size (Area index %)

| | |
|---|---|
| Glassy Membrane in First Stage | 100 |
| Membrane Unit 24 | |
| Rubbery Membrane in Second Stage | 2.5 |
| Membrane Unit 58 | |

Process Electrical Drives (MW)

| | |
|---|---|
| Tail Gas Compressor 12 | 8.62 |
| Compressor 40 | 4.13 |
| Cryogenic Cooler 48 | 1.22 |
| Liquid Pump 72 | 0.11 |
| Turbo-expander 30 | −1.76 |
| Total electrical power required (MW) | 12.32 |

CO₂ and H₂ Recovery % (Purity %)

| | |
|---|---|
| Liquid carbon dioxide 54 | 90.8 |
| | (97.7) |
| Hydrogen product stream 70 | 95.0 |
| | (92.4) |

The power demand in Table 10 does not include power needed, if any, for molecular centrifuge unit 110. The results and material balance of the streams are shown in Table 11.

TABLE 11
Material balance of streams of Example 5.

| Stream | 10 | 22 | 28 | 26 | 38 | 54 | 56 |
|---|---|---|---|---|---|---|---|
| Temperature, ° C. | 48.9 | 30 | 25 | 25 | −26.7 | −37.8 | 26.7 |
| Pressure, psig | 2 | 300 | 300 | 1 | 434 | 434 | 434 |
| Flow, MMSCFD | 56.7 | 51.0 | 34.4 | 16.6 | 22.8 | 11.8 | 11.0 |

Component, vol %

| | | | | | | | |
|---|---|---|---|---|---|---|---|
| Hydrogen | 2.40 | 2.67 | 0.00 | 8.21 | 10.82 | 0.31 | 22.11 |
| Argon | 0.72 | 0.80 | 0.93 | 0.53 | 0.47 | 0.09 | 0.87 |
| Nitrogen | 64.36 | 71.60 | 95.65 | 21.52 | 18.13 | 1.88 | 35.57 |
| CO | 0.02 | 0.02 | 0.03 | 0.02 | 0.01 | 0.00 | 0.03 |
| CO₂ | 22.40 | 24.91 | 3.39 | 69.73 | 70.56 | 97.72 | 41.42 |
| H₂S | 200 ppm | <20 ppm | <20 ppm | <20 ppm | <20 ppm | <20 ppm | <20 ppm |
| H₂O | 10.08 | <20 ppm | <20 ppm | <20 ppm | <20 ppm | <20 ppm | <20 ppm |

| Stream | 60 | 62 | 70 | 68 | 36 | 74 |
|---|---|---|---|---|---|---|
| Temperature, ° C. | 13.3 | 17.8 | 26.7 | 30 | 17.8 | 8.9 |
| Pressure, psig | 1 | 434 | 20 | 50 | 1 | 2200 |
| Flow, MMSCFD | 6.2 | 4.8 | 1.4 | 3.5 | 37.9 | 11.8 |

Component, vol %

| | | | | | | |
|---|---|---|---|---|---|---|
| Hydrogen | 17.83 | 27.62 | 92.36 | 1.55 | 0.14 | 0.31 |
| Argon | 0.3 | 1.61 | 0.28 | 2.15 | 1.04 | 0.09 |
| Nitrogen | 9.05 | 69.78 | 7.29 | 94.94 | 95.58 | 1.88 |
| CO | 0.01 | 0.05 | 0.00 | 0.07 | 0.03 | 0.00 |
| CO₂ | 72.81 | 0.94 | 0.07 | 1.29 | 3.20 | 97.72 |
| H₂S | <20 ppm | <20 ppm | <20 ppm | <20 ppm | <20 ppm | <20 ppm |
| H₂O | <20 ppm | <20 ppm | <20 ppm | <20 ppm | <20 ppm | <20 ppm |

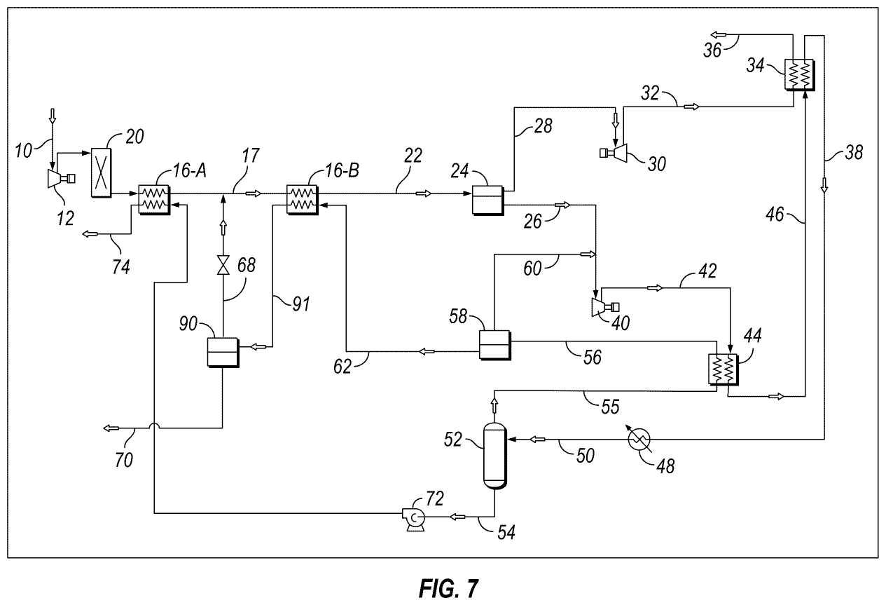

Example 6. Example 6 was a simulation of an embodiment of the membrane carbon capture and hydrogen recovery process, where the hydrogen recovery process included a hydrogen recovery membrane. FIG. 7 is a simplified depiction of the process layout used in the simulation.

In Example 6, the impact of hydrogen in the tail gas stream 10 is shown by varying the amount from 0 vol % to 1 vol %. Hydrogen recovery process 64 includes hydrogen recovery membrane 90. Hydrogen recovery membrane 90 was simulated as the glassy membrane used in Example 1 with the selectivity data defined in Table 1. First stage membrane unit 24 also included the glassy membrane used in Example 1. Second stage membrane unit 58 was simulated with the same rubbery membrane selectivities as used in Example 1. Rubbery membrane retentate 62 is pre-heated through exchange with second cooler 16-B before being introduced to hydrogen recovery membrane 90. Carbon dioxide lean stream 68 is mixed with pre-cooled vent stream 17 and recycled to first stage membrane unit 24. Table 12 provides the area of each membrane relative to the area required by the glassy membrane in first stage membrane unit 24.

TABLE 12
Performance parameters and recovery data of Example 6.

| | | | |
|---|---|---|---|
| % H₂ in tail gas stream 10 | 0.0% H₂ | 0.5% H₂ | 1.0% H₂ |

Membrane size (Area Index %)

| First Stage Membrane Unit 24 | 100 | 100 | 100 |
|---|---|---|---|
| Second Stage Membrane Unit 58 | 0.27 | 0.98 | 1.18 |
| Hydrogen Recovery Membrane 90 | 0.0 | 0.14 | 0.18 |
| Process Electrical Drives (MW) | | | |
| Tail Gas Compressor 12 | 8.62 | 8.62 | 8.62 |
| Compressor 40 | 3.27 | 3.88 | 4.51 |
| Cryogenic Cooler 48 | 1.1 | 1.0 | 1.0 |
| Liquid Pump 72 | 0.11 | 0.11 | 0.11 |
| Turbo-expander 30 | −2.0 | −2.0 | −2.0 |
| Total electrical power required (MW) | 11.12 | 11.58 | 12.23 |
| Cryogenic Cooler Temperature (° C.) | −37.8 | −37.8 | −37.8 |
| | MMSCFD | MMSCFD | MMSCFD |
| Stream Parameters | % CO₂/% H₂ | % CO₂/% H₂ | % CO₂/% H₂ |
| Dry Stream 22 | 55.7 | 56.31 | 57.9 |
| | 25.4/0 | 23.9/2.6 | 23.8/5.2 |
| Permeate Stream 26 | 16.55 | 17.4 | 19.2 |
| | 76.6/0 | 69.2/8.5 | 64.1/15.7 |
| Cryogenic Feed 38 | 18.04 | 21.5 | 24.6 |
| | 78.1/0 | 72.3/8.6 | 68.3/15.1 |
| Membrane Feed 56 | 6.17 | 9.7 | 12.8 |
| | 42.24/0 | 41.6/18.7 | 41.2/28.6 |
| Rubbery Membrane Permeate 60 | 1.48 | 4.1 | 5.3 |
| | 94.88/0 | 85.4/9.2 | 83.3/13.0 |
| % CO₂ Recovery (Overall Process) as Liquid | 89.8 | 90.0 | 89.9 |
| % H₂ Recovered (% purity) | 0 | 89.1 (88.2) | 93.9 (91.6) |

In each simulation the size of the membrane in first stage membrane unit 24 was maintained as the same. In the first run, where the amount of hydrogen in tail gas stream 10 was 0 vol %, the size of the membrane for hydrogen recovery membrane 90 was set to 0 because it was not needed as there was no hydrogen to be recovered. Effectively, in the first run simulation, rubbery membrane retentate 62 was recycled to form part of dry stream 22.

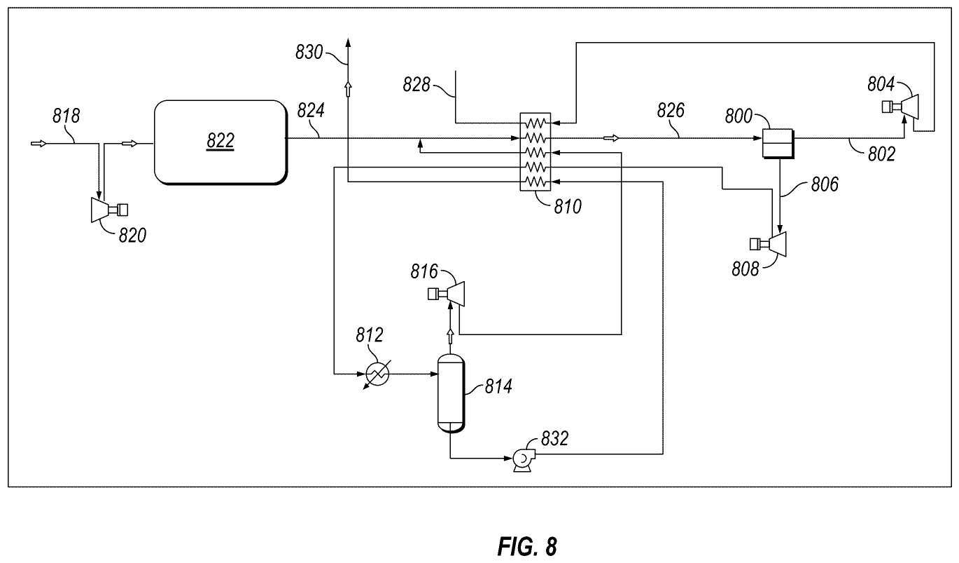

Example 7. Example 7 was a simulation of an embodiment of a tail gas treatment unit of the prior art. FIG. 8 is a simplified depiction of the process layout used in the simulation. The tail gas treatment process includes membrane unit 800 containing a polyimide based glassy membrane selective to carbon dioxide over nitrogen. Membrane unit 800 operates at cryogenic temperatures to enhance membrane selectivity and maximize separation efficiency. Membrane unit reject 802, which is mainly nitrogen, is expanded in turbine 804 to recover power and produce a cold stream. The primary purpose of the turbine is to economize cooling of other streams in exchanger 810. Membrane unit permeate 806 is compressed in compressor 808 and then cryogenically cooled in cryogenic unit 812. The cryogenically cooled stream can be separated in separator 814 to collect the liquid carbon dioxide and separate the gases for recycling to the feed membrane. Flue gas 818 is free of hydrogen and can be pre-treated in flue gas compressor 820 and flue gas pre-treater 822 to remove sulfur compounds and water vapor. The pre-treated and cooled stream is introduced to membrane unit 800 as feed 826. The tail gas treatment process can produce exhaust gas 828 and pressurized carbon dioxide 830. Table 13 provides the selectivity for carbon dioxide over other gases used in the simulation for the membrane in membrane unit 800.

TABLE 13

| Selectivity for membranes used in Example 7. | |
|---|---|
| | Nitrogen Rejective |
| | Membrane |
| | CO₂ = 25 GPU |
| Gas | CO₂/Gas |
| Hydrogen | 0.5 |
| Argon | 20 |
| Nitrogen | 80 |
| CO | 20 |
| CO₂ | 1 |
| H₂S | 1 |
| H₂O | 0.12 |

Table 14 lists the material balance for the major streams of the process.

TABLE 14
Material balance of streams of Example 7, run 1.

| Stream | 818 | 824 | 826 | 806 | 828 | 830 |
|---|---|---|---|---|---|---|
| Temperature, ° C. | 48.9 | 48.9 | −30 | −38.3 | 21.1 | 28.3 |
| Pressure, psig | 2 | 300 | 300 | 1 | 1 | 2200 |
| Flow, MMSCFD | 56.7 | 51.0 | 54.3 | 15.2 | 39.2 | 11.8 |

Component, vol %

| | | | | | | |
|---|---|---|---|---|---|---|
| Hydrogen | 0.0 | 0.00 | 0.00 | 0.00 | 0.00 | 0.00 |
| Argon | 0.72 | 0.80 | 0.87 | 0.62 | 0.97 | 0.22 |
| Nitrogen | 66.76 | 74.27 | 73.1 | 14.51 | 95.73 | 3.08 |
| CO | 0.02 | 0.02 | 0.02 | 0.02 | 0.02 | 0.00 |
| CO₂ | 22.40 | 24.91 | 26.01 | 84.86 | 3.27 | 96.7 |
| H₂S | 200 ppm | <20 ppm | <20 ppm | <20 ppm | <20 ppm | <20 ppm |
| H₂O | 10.08 | <20 ppm | <20 ppm | <20 ppm | <20 ppm | <20 ppm |

To illustrate the impact of the presence of hydrogen in the feed stream, Table 15 compares the impact of the presence of hydrogen in the feed stream on the overall process performance. The amount of hydrogen in flue gas 818 was varied in different simulation runs from 0.0% to 1.0%. The size of the membrane unit was maintained in each run. As shown in Table 15, as the amount of hydrogen content in flue gas 818 is increased, the size of feed 826 to membrane unit 800 and the size of membrane unit permeate 806 both increase. Due to the increase in volume, hydrogen increases in the process streams as the amount of hydrogen content in flue gas 818 increases. Consequently, the size of compressor 808, and its power demand, increased substantially. Similarly, the power demand of cryogenic unit 812 increased as the flow rate of membrane unit permeate 806 increased and cooling to lower temperature is required due to the increase in the amount of non-condensable hydrogen. A major source of the power produced is from the turbine acting on membrane unit reject 802 from membrane unit 800. The flow rate of membrane unit reject 802 does not vary between the runs and therefore turbine 804 power extracted does not change.

Table 15 provides the area of each membrane relative to the area required by the glassy membrane in first stage membrane unit 24.

TABLE 15
Performance parameters and recovery data of Example 7.

| | 0.0% | 0.5% | 1.0% |
|---|---|---|---|
| | H2 | H2 | H2 |
| Membrane unit size (%) | 100 | 100 | 100 |
| Process Electrical Drives (MW) | | | |
| Flue gas compressor 820 | 8.62 | 8.62 | 8.62 |
| Compressor 808 | 2.65 | 5.28 | 10.74 |
| Cryogenic unit 812 | 1.0 | 1.9 | 2.40 |
| Liquid CO₂ Pump 832 | 0.11 | 0.10 | 0.096 |
| Turbine 804 | −1.82 | −2.0 | −2.0 |
| Total electrical power | 10.6 | 13.9 | 19.8 |
| required (MW) | | | |
| Cryogenic Cooler | −37 | −45 | −51 |
| Temperature (° C.) | | | |
| Feed 826 (MMSCFD) | 54.3 | 68.9 | 99.7 |
| Feed 826 % CO₂/% H₂ | 26.0/0.0 | 26.3/15.4 | 24.5/35.7 |
| Membrane unit permeate | 15.2 | 29.5 | 60.0 |
| 806 (MMSCFD) | | | |
| Membrane unit permeate | 84.9/ | 57.2/ | 38.1/ |
| 806 % CO₂/% H₂ | 0.0 | 35.5 | 58.7 |
| % CO₂ Recovery | 89.9 | 89.8 | 87.6 |
| (Overall Process) as Liquid | | | |
| % H₂ Recovered | 0 | 0 | 0 |

Tail gas treatment of the prior art deploying cryogenic carbon dioxide process with glassy membrane in significant concentration of hydrogen in the process streams along with carbon dioxide. This results in significant increase in equipment size and power demand and precipitation of liquid carbon dioxide becomes harder and increasingly colder temperatures to effectively precipitate the carbon dioxide. These results are observed because the nitrogen rejective membrane is selective to hydrogen more than carbon dioxide, which results in concentrating hydrogen along with carbon dioxide while nitrogen is rejected.

Comparing Examples 6 and 7, in Example 6, the carbon dioxide recovery can be maintained between runs by increasing the size of the membrane in second stage membrane unit 58 and hydrogen recovery membrane 90, whereas in the tail gas treatment of Example 7 the temperature in cryogenic unit 812 has to be reduced to maintain the same level of overall carbon dioxide recovery, which resulted in increase in cryogenic refrigeration power demand. Comparing Examples 6 and 7 illustrates the advantages of removing hydrogen to prevent concentrating in the process streams while maintaining the same level of carbon dioxide recovery and the unexpected results of maintaining power demand across the system and ability to operate membranes at near room temperature. Advantageously and unexpectedly, the use of a rubbery membrane in the second stage membrane unit can compensate for the low selectivity of carbon dioxide in the glassy membrane of the first stage membrane unit.

Although the present disclosure has been described in detail, it should be understood that various changes, substitutions, and alterations can be made without departing from the principle and scope of the disclosure. Accordingly, the scope of the present disclosure should be determined by the following claims and their appropriate legal equivalents.

The singular forms “a,” “an,” and “the” include plural referents, unless the context clearly dictates otherwise.

Ranges may be expressed throughout as from about one particular value, or to about another particular value. When such a range is expressed, it is to be understood that another embodiment is from the one particular value or to the other particular value, along with all combinations within said range.

What is claimed is:

1. A process to recover carbon dioxide and hydrogen from a tail gas stream, the process comprising the steps of:
compressing the tail gas stream in a tail gas compressor to produce a compressed tail gas stream, where the tail gas stream comprises hydrogen, carbon dioxide, nitrogen and impurities;
treating the compressed tail gas stream in a pre-treatment unit to remove the impurities to produce a dry stream;
separating the dry stream in a first stage membrane unit to produce a permeate stream and a retentate stream, where the first stage membrane unit comprises a membrane selective to carbon dioxide and hydrogen over nitrogen, where the permeate stream comprises carbon dioxide and hydrogen, where the retentate stream comprises nitrogen;
expanding the retentate stream in a turbo-expander to produce an expanded stream;
compressing the permeate stream in a compressor to produce a compressed permeate stream;
cooling the compressed permeate stream in a permeate exchanger to produce a cooled permeate stream;
reducing a temperature of the cooled permeate stream in an exhaust exchanger to produce a cryogenic feed, where the temperature of the cooled permeate stream is reduced by heat exchange with the expanded stream;
reducing a temperature of the cryogenic feed in a cryogenic cooler to produce a cryogenic stream, where a temperature of the cryogenic stream induces precipitation of carbon dioxide at the pressure of the cryogenic stream;
separating the cryogenic feed in a knock-drum to produce a liquid carbon dioxide and membrane feed, where the knock-out drum is at the temperature and pressure of the cryogenic stream, where the liquid carbon dioxide comprises the precipitated liquid carbon dioxide, where the membrane feed comprises carbon dioxide and hydrogen;
separating the membrane feed in a second stage membrane unit to produce a rubbery membrane permeate and a rubbery membrane retentate, where the second stage membrane unit comprises a membrane selective to carbon dioxide over hydrogen, where the rubbery membrane permeate comprises carbon dioxide, where the rubbery membrane retentate comprises hydrogen; and
treating the rubbery membrane retentate in a hydrogen recovery process to produce a hydrogen product stream and a carbon dioxide lean stream, where the hydrogen recovery process is selected from the group consisting of a pressure swing adsorption unit, a hydrogen recovery membrane, a molecular centrifuge, and combinations of the same, where the hydrogen product comprises hydrogen.

2. The process of claim 1, where the tail gas stream further comprises argon, helium, and carbon monoxide.

3. The process of claim 1, where the impurities are selected from hydrogen sulfide, water vapor, and combinations of the same.

4. The process of claim 1, where the compressed tail gas stream is at a pressure between 250 psig and 350 psig.

5. The process of claim 1, where the pre-treatment unit comprises molecular sieves.

6. The process of claim 1, where the compressed permeate stream is at a pressure between 410 psig and 460 psig.

7. The process of claim 1, further comprising the step of: increasing a temperature of the expanded stream in the exhaust exchanger to produce an exhaust, where the exhaust comprises greater than 90 vol % nitrogen.

8. The process of claim 1, where the membrane feed further comprises nitrogen and the rubbery membrane retentate further comprises nitrogen.

9. The process of claim 1, further comprising a carbon dioxide rich stream produced from the hydrogen recovery process.

10. The process of claim 1, where the hydrogen product comprises greater than 90 vol % hydrogen.

11. The process of claim 1, where the hydrogen recovery process comprises one or more pressure swing adsorption units.

12. The process of claim 1, where the hydrogen recovery process comprises one or more gas separation membranes selective to hydrogen over nitrogen.

13. The process of claim 1, further comprising the step of mixing the carbon dioxide lean stream with the retentate stream, where the carbon dioxide lean stream comprises nitrogen.

14. The process of claim 1, further comprising the step of mixing the carbon dioxide lean stream with the exhaust, where the carbon dioxide lean stream comprises nitrogen.

15. The process of claim 1, further comprising the step of mixing the rubbery membrane permeate with the permeate stream.

16. The process of claim 1, further comprising the step of increasing a pressure of the liquid carbon dioxide to produce a carbon dioxide product.

17. A system to recover carbon dioxide and hydrogen from a tail gas stream, the system comprising:
a tail gas compressor, the tail gas compressor configured to compress the tail gas stream to produce a compressed tail gas stream, where the tail gas stream comprises hydrogen, carbon dioxide, nitrogen and impurities;
a pre-treatment unit fluidically connected the tail gas compressor, the pre-treatment unit configured to treat the compressed tail gas stream to remove the impurities to produce a dry stream;
a first stage membrane unit fluidically connected to the pre-treatment unit, the glassy membrane configured to separate the dry stream to produce a permeate stream and a retentate stream, where the first stage membrane unit comprises a membrane selective to carbon dioxide and hydrogen over nitrogen, where the permeate stream comprises carbon dioxide and hydrogen, where the retentate stream comprises nitrogen;
a turbo-expander fluidically connected to a retentate side of the first stage membrane unit, the turbo-expander configured to expand the retentate stream to produce an expanded stream;
a compressor fluidically connected to a permeate side of the first stage membrane unit, the compressor configured to produce a compressed permeate stream;
a permeate exchanger fluidically connected to the compressor, the permeate exchanger configured to cool the compressed permeate stream to produce a cooled permeate stream;
an exhaust exchanger fluidically connected to the permeate exchanger and the turbo-expander, the exhaust exchanger configured to reduce a temperature of the cooled permeate stream to produce a cryogenic feed, where the temperature of the cooled permeate stream is reduced by heat exchange with the expanded stream;
a cryogenic cooler fluidically connected to the exhaust exchanger, the cryogenic cooler configured to reduce a temperature of the cryogenic feed to produce a cryogenic stream, where a temperature of the cryogenic stream induces precipitation of carbon dioxide at the pressure of the cryogenic stream;
a knock-drum fluidically connected to the cryogenic cooler, the knock-out drum configured separate the cryogenic feed to produce a liquid carbon dioxide and membrane feed, where the knock-out drum is at the temperature and pressure of the cryogenic stream, where the liquid carbon dioxide comprises the precipitated liquid carbon dioxide, where the membrane feed comprises carbon dioxide and hydrogen;
a second stage membrane unit fluidically connected to the knock-out drum, the rubbery membrane configured to separate the membrane feed to produce a rubbery membrane permeate and a rubbery membrane retentate, where the second stage membrane unit comprises a membrane selective to carbon dioxide over hydrogen, where the rubbery membrane permeate comprises carbon dioxide, where the rubbery membrane retentate comprises hydrogen; and
a hydrogen recovery process fluidically connected to a retentate side of the second stage membrane unit, the hydrogen recovery process configured to treat the rubbery membrane retentate to produce a hydrogen product stream and a carbon dioxide lean stream, where the hydrogen recovery process is selected from the group consisting of a pressure swing adsorption unit, a hydrogen recovery membrane, a molecular centrifuge, and combinations of the same, where the hydrogen product comprises hydrogen.

18. The system of claim 17, where the pre-treatment unit comprises molecular sieves.

19. The system of claim 17, where the hydrogen recovery process comprises one or more pressure swing adsorption units.

20. The system of claim 17, where the hydrogen recovery process comprises one or more gas separation membranes selective to hydrogen over nitrogen.
